(19) United States
(12) Patent Application Publication
(10) Pub. No.: US 2022/0067628 A1
(43) Pub. Date: Mar. 3, 2022

(54) DIRECTIONAL STREAM VALUE ANALYSIS SYSTEM AND SERVER

(71) Applicant: AVEVA Software, LLC, Lake Forest, CA (US)

(72) Inventors: Robert Mill, Lake Forest, CA (US); Granville Paules, IV, Lake Forest, CA (US); Matthew Coombes, Lake Forest, CA (US); Norbert Raus, Lake Forest, CA (US); Maciej Zieba, Lake Forest, CA (US); Rafal Nowak, Lake Forest, CA (US); Jeremi Kaczmarczyk, Lake Forest, CA (US); Piotr Semberecki, Lake Forest, CA (US)

(21) Appl. No.: 17/525,478

(22) Filed: Nov. 12, 2021

Related U.S. Application Data
(63) Continuation of application No. 16/591,411, filed on Oct. 2, 2019.
(60) Provisional application No. 62/740,276, filed on Oct. 2, 2018.
(60) Provisional application No. 62/740,322, filed on Oct. 2, 2018.
(60) Provisional application No. 62/740,339, filed on Oct. 2, 2018.

(51) Int. Cl. G06Q 10/06; G06K 9/62; G06Q 10/04

(52) U.S. Cl. CPC G06Q 10/06393; G06Q 10/04; G06K 9/6262

(57) ABSTRACT

A system for improving performance includes a processor and a non-transitory computer readable medium. The system comprises instructions which can include assigning an agent corresponding to discrete decision points and assigning a scope based on a facility topology, and training the agent to learn a decision policy which provides a ranking for each of a possible decision that agents can take for a given scenario at any point in time. The ranking can be determined during a training phase by selecting actions that maximize one or factors of a global reward, the global reward accumulating the value of all facility operations over a duration of a scheduling period.

### CROSS-REFERENCE TO RELATED APPLICATIONS

This application is a Continuation Application of U.S. patent application Ser. No. 16/591,411, filed Oct. 2, 2019, entitled, “DIRECTIONAL STREAM VALUE ANALYSIS SYSTEM AND SERVER,” which claims the benefit of and priority to U.S. Provisional Application No. 62/740,276, filed Oct. 2, 2018, entitled, “DIRECTIONAL STREAM VALUE ANALYSIS SYSTEM AND SERVER”, and U.S. Provisional Application No. 62/740,322, filed Oct. 2, 2018, entitled “GLOBAL ECONOMIC AND CRITICAL CONSTRAINT ANALYSIS SYSTEM AND SERVER” and U.S. Provisional Application No. 62/740,339, filed Oct. 2, 2018, entitled “AUGMENTED DECISION SUPPORT FOR PLANT SCHEDULING SYSTEM AND SERVER”, the entire contents of which are incorporated herein by reference.

### BACKGROUND

Many industrial processes are becoming more complex over time. Analyzing and optimizing such processes is therefore becoming more complex as well.

Some embodiments of the invention assign a value and flow directionality to materials at some point in a complex industrial process using a topologically-informed optimization model.

Stream values are a familiar concept in the oil industry. As used herein, a stream value refers to the optimal additional profit that the optimizer could achieve, if it were provided with an extra unit of material at some arc in the model, for example, in a pipe or on a transport.

Some embodiments of the invention provide the computation and display of further explanatory information alongside the stream value—information very useful for its correct interpretation. Specifically, some embodiments report: changes in material flow in the pipe in response to an extra unit; the marginal flows of other materials in the pipe; and the economic implications of this pattern of adjustments.

This quantitative data is valuable to traders, refinery economists, process engineers and linear program (LP) analysts. Some embodiments enable the data to be rapidly reassembled from the detailed output of a LP as a postprocessing step, so its recovery does not impinge on the solution of the original optimization problem.

Nonlinear programs modelling complex industrial processes (such as refineries or networks thereof) encode in the state of their final, optimized linear program a wealth of economic and differential data. This information, once extracted, can be of great value to an analyst.

In some embodiments of the invention, this information is processed and presented to the user in a high-level, accessible, and customisable fashion. Some embodiments provide Global Economic Analysis (GEA) that enables the user of an optimization software tool (such as Spiral Suite commercially available from AVEVA Group plc) to decompose a set of marginal “causes” into a series of “effects”, and view the effect sizes as a tabulation, each along with the economic impact.

The goal of plant scheduling is to provide a set of operating instructions for a plant execution or operations team (e.g. such as ship arrival discharges, process unit feeds, etc.) Forecasting future decisions is a very challenging process due to the dynamics of the environment, and the uncertainty, which requires “what-if” consideration to produce robust decisions. Robust decisions don't need to be constantly changed and can maintain desired goals despite fluctuations in the input data (e.g. such as ship arrival time).

Plant scheduling generally comprises many individual decisions (referred to above as decision points), such as choosing a destination tank for a particular ship discharge, selecting a line-up of tanks for CDU feed or component selection for blend, etc. In addition, each individual decision can be impacted or impact other decisions due to shared resources within plant topology (e.g. tanks, lines, pumps, etc.) The task of foreseeing this causal effect is challenging due to the size of the problem and number of decisions.

At present, it is challenging to find a feasible solution to ensure that all the environmental constraints are satisfied, (e.g., such as avoiding spilling oil over the tanks). In addition, safety needs to be accounted for, and all operating limits must be respected. Further, while staying feasible is the major concern, a plant schedule needs to stay profitable, with the schedule expected to follow an optimized average plan. The use of existing solutions can be time consuming, and very little time is left to adjust schedules to closely follow a profitable plan.

### DESCRIPTION OF THE DRAWINGS

FIG. 1 schematically illustrates two process units P1 and P2 in a refinery with a pipe S (or, alternatively, on a geographical scale, two plants in a network with a transport.)

FIG. 2 shows a crude distillation unit which distills two input components into three tower output products.

FIG. 3 illustrates a computer system enabling or comprising the systems and methods in accordance with some embodiments of the invention.

A crib sheet that describes the directional stream value analysis report for a crude distillation unit (CDU) is attached as Exhibit A.

An example spreadsheet produced according to a directional stream value analysis is provided as Exhibit B.

A crib sheet which makes the case for critical constraint analysis is attached as Exhibit C.

A crib sheet which makes the case for global economic analysis is attached as Exhibit D.

Exhibit E includes User Interface Designs.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Sequential linear optimization software such as Spiral Suite which is commercially available from AVEVA Group plc is used in industry to maximise profit (or other objectives) by adjusting: the quantities in which to purchase feedstocks (trading of crudes); the configuration of industrial units, transportation of materials, etc. (operations); subject to mathematically-encoded physical, operational, environment, legal constraints.

Post-optimization, the user can request stream values. A stream value relates the value of an extra unit of material in the plant as judged by the optimization program.

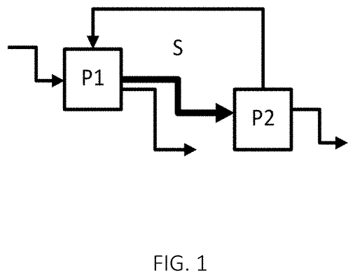

One technical problem faced by the user is that the stream value alone does not convey whether the value derives from downstream or upstream, that is, how the optimizer has decided to use the extra unit. To give a concrete example, suppose the user connects two process units P1 and P2 in a refinery with a pipe S (or, alternatively, on a geographical scale, two plants in a network with a transport) in a flowsheet, as schematically illustrated in FIG. 1.

If the user selects the bold link and requests its stream value, they remain ignorant as to whether the value derives from: a reduction in the output of P1 (which saves money); increase in the consumption of P2 (which makes profit); or a complex combination of (1) and (2), mediated by recycle pathways or network-global constraints as shown in FIG. 1.

Currently, to make this determination, an analyst would have to run additional optimizations with small, intrusive adjustments, or consult with a specialist; either of which is time-consuming, expensive, and error-prone.

The benefit of some embodiments of the invention is that it returns the stream value and its breakdown in a way that embodies directional information. For example, it would resolve the ambiguity faced by the analyst described above, e.g., if an extra unit is valued at $100 it will report this as being due to (1), (2) or (3). Furthermore, the user is informed of which other materials in the pipe are backed out to P1 or drawn into P2, and in what quantities, along with the economic impacts due to these flow adjustments. The mathematical techniques to compute these data are rapid and stable, as they require no additional simulations or linear program re-solves. This speeds up the workflow of the analyst and provides an intuitive feel for the “flow” of economic value in the model.

Consider a crude distillation unit which distils two input components into three tower output products:

If a unit of x is injected into the tower and a stream value of $56 per barrel is returned then various scenarios are possible: that it will be distilled directly to fractions of x₁, z₂ and x₃, with the relative flow of y unaffected. In this case, the value will come from the sum of these product values; that the tower cannot process x, and so the value comes from a refund of x; that injecting a unit of x causes y to be backed out, in which case some of a value of x comes from a refund of y, and some value is lost due the backing out of sold products y₁, y₂ and y₃; that a complex rebalancing of x and y takes place in order to maintain other constraints, in which case the value comes from a pattern of changes due to upstream refunds and downstream sales.

Without some embodiments of the invention, all the user has access to is the value of material according to the optimizer, namely, $56 per barrel. An innovation of some embodiments is that the user can now see the rebalancing of feed materials and outputs that yielded this value. Any decisions made based on this valuation of $56 per barrel are now made in the light of this rich contextual reporting, not based on the figure in isolation.

Some embodiments of the invention provide an algorithm that computes the differential changes in stream component flows in the optimized solution of a linear program in response to the injection of material with fixed properties.

Some embodiments of the invention provide an algorithm that decomposes the stream value based on the economic impacts of interactions with downstream model constituents—whose novelty at least partially resides in the fact that the contributions are adjusted according to marginal component flows of other materials in the pipe.

In some embodiments of the invention, these culminate in the software's provision of a workflow which allows a unit of modelled material (e.g., crudes) to be injected into to a pipe, and the relative amounts of other modelled materials that are backed out or brought in—along with their economic impacts—is reported. In some embodiments of the invention, the downstream economic impacts are adjusted to account for the feed rebalancing.

1. Computing Differential Changes in Stream Component Flows

In some embodiments of the invention, computing the differential changes in component stream flows takes place in three stages. The first two are pre-optimization; the third is post-optimization.

First, whilst the nonlinear problem is being constructed, the topological relation of each flow variable (to be analyzed) is recorded in relation to any equation in which it is incident with a nonzero coefficient. For instance, a flow variable may participate in a flow balance in an upstream or downstream sense.

Second, the pattern of derivatives required to compute the stream component flow changes is established. For instance, if we are to inject a unit of material 1 in units of weight, corresponding to the flow variable w₁ in stream S, then we may need to monitor the change in the variable tracking an adjacent volume component of material 2, v₂.

Third, after the sequential linear program is optimized, the post-solved augmented linear program matrix returned at the final iteration of an LP (A) is interrogated. When a unit of flow is injected, the changes in other flow components can be obtained via the appropriate inner product of elements in A⁻¹ with nonzero coefficients in A that correspond to intersections of the injected flow variable with topologically downstream rows.

2. Decomposing the Stream Value Based on Economic Impacts

In some embodiments of the invention, the economic impact of an injection of flow to variable j due to equation indexed i is [A]ᵢⱼ×γᵢ where γᵢ is the dual value on row i. This is a traditional marginal-coefficient breakdown. The stream value is recovered by summing the downstream (or upstream) economic impacts.

A directional stream value breakdown is obtained by weighting the downstream and upstream impacts are according to the change in flow of the injection component. Summing the directional stream value breakdown gives the same stream value as a marginal-coefficient breakdown.

If there it is a multi-component stream (i.e. one with many materials) then some embodiments of the invention present a stream value breakdown for an injection of j by computing the following: we compute the backed-out stream value due to component k as the backed-out flow of component k (computed in (1) above) multiplied by the stream value of component k; and we start with the marginal coefficient breakdown of component j and subtract the marginal-coefficient breakdown for component k weighted by the marginal downstream flow of component k in response to an injection of component j.

In some embodiments of the invention, following this procedure delivers two sets economic impacts: the economic impacts due to backed out (e.g., refunded) components; and the residual economic impacts due to material processed downstream.

3. Provision of a Workflow

The user would be expected to optimize the problem and then be able to view this data. The information described in (1) and (2) can be repackaged for user presentation by various means, e.g., user interface, external reports. Some embodiments of the invention produce a report which takes the mathematics described in the preceding two sections and embodies it in the equations of an Excel report. This allows the user to inject materials which the optimizer has not seen, by adjusting the coefficients on the property and yield balances accordingly.

Once a model has been optimized, analysts wish to examine the effects of small changes to the model. Some examples of work-flow in this category include: reading the marginals (how does the profit change if a constraint is adjusted?); and reading the stream values (how does the profit change if a small unit of material is made available in this pipe?).

Marginals and stream values are useful, but in isolation, there is no explanation as to why they assume the values they do without detailed examination of, or expert acquaintance with, the model. Some refinery and network models are so complex, that these latter alternatives are impractical. (In contrast, GEA enables the user to break down the marginal; see below.)

Besides these approaches, if a user wishes to monitor other kinds of changes they may run a sensitivity analytic case stack. An analytic re-solves same model many times, each time stepping a nominated parameter across a predefined range. The user can then inspect the solution at each data point.

Sensitivity analytics are very useful but are disadvantageous in some regards. They involve multiple re-runs of the same model, which consumes time and computational resources, and returns a large volume of information. The fact that only a single parameter is being changed suggests that computational work related to other aspects of the optimization is being repeated. Because the model is nonlinear and potential numerically sensitive, re-solving runs the risk of a quantitative step change occurring in the solution between neighbouring cases due to a basis change or switching between local optima. Finally, because one analytic only addresses a single parameter, the desire to collect together and see the effect of many changes implies the maintenance and solution of many analytics.

Global Economic Analysis is a linear sensitivity analysis which empowers the user to decide for themselves which quantities they wish to perturb (causes) and the resultant changes they want to measure (effects). In some embodiments, having specified the desired causes and effects in a configurable grid, the user can run the optimizer and recover the relations between the causes and effects very rapidly and stably. In some embodiments, these results are based entirely on a single run on the linear program. Furthermore, the process of recovering this information is not intrusive on the program statement; that is, the computations that populate the cause-and-effect grid do not impinge on the solution trajectory of the optimization.

In some embodiments, causes include: an adjustment to a constraint and/or the injection of a small amount of material at a location in the model.

In some embodiments, effects include: changes in purchases and sales; changes to the flow or properties of materials in pipes; and/or changes to calculations results and operating parameters.

In some embodiments, the ability to pair these causes and effects combinatorically enables the user to address a subset of millions of potential questions according to their needs.

Some embodiments provide novel, highly configurable grids that register marginal effects against their causes.

In some embodiments, the framework in which marginals and a stream values are conceived of as building-block “causes” and the resultant changes in the model as “effects” which can be combined.

Some embodiments enable the configuration of a grid by drawing from a dictionary of causes and effects.

Some embodiments enable the population of this grid, post-optimization, with numerical changes in effects and their economic impacts.

Some embodiments provide the workflow that involves decomposing a cause into a set of effects to understand the cause. This corresponds to reading down a column in the cause-effect grid and noting the resultant effects.

Some embodiments provide the workflow that involves examining which causes would be able to bring about or counteract an effect (critical constraint analysis). This corresponds to reading across a row in the cause-effect grid and noting the responsible causes.

In some embodiments, the configuration of the grid of causes and effects in the user interface constitutes a request mechanism. The collections of causes and effects are passed to the optimization engine, and are consulted while the nonlinear problem is being constructed.

In some embodiments, during problem construction, it is noted which effects are to be measured against which causes. It is anticipated which derivatives will be required post-solve, and these are recorded.

In some embodiments, after the problem is solved, the cause and effect grid requested is consulted again, and the final solution state of the linear program, including its derivatives, are examined to reconstruct the effect size. An economic impact is attached to the effect if it is linked to a price.

In some embodiments, in the case of a stream value/injection acting as a cause, the relations between weight and volume components in the same pipe are resolved. In the case of causes and effects referring to properties that blend non-trivially (i.e. using a model blend rule), incremental re-blending via an index is accomplished using the appropriate combination of chain, product and quotient rules.

In some embodiments of the invention comprise the use of a multi-agent architecture for a plant (refinery and/or mine) scheduling problem. In that architecture, each agent corresponds to discrete decision points, and is assigned the scope based on the plant topology.

In some embodiments of the invention, all agents can be trained to learn the decision policy. The decision policy provides the ranking for each of the possible decisions that agents can take for a given scenario at each point in time. In some embodiments, in any decision policy, for every time point when a decision is required, a quantitate measure (e.g., an action-value) for each possible decision at that point can be made. In some embodiments, the ranking can be obtained during a training phase by selecting actions that maximize the notion of global reward.

Some embodiments comprise a global reward that can accumulate the value of all plant operations over the duration of the plan scheduling period. In some embodiments, the training phase can be for an agent to learn a decision policy. In some embodiments, it can be based on historical data (decision from the past), simulation-based data obtained by sampling input data (e.g., using a Monte Carlo simulation), or both. In some embodiments of the invention, the data can provide an input scenario for each agent to perform a number of training episodes, where each one explores a different sequence of decisions and its final global reward. In this instance, the training agent can update the ranking of each of the decisions that participated in the decision sequence based on the final global reward.

In some embodiments, once an agent's policy is trained, it can be used in the prediction phase on the future scheduling scenarios to recommend scheduling decisions. Finally, in some embodiments, during a prediction phase, each agent can recommend a whole schedule (e.g., a full-run), and guide the user with each decision (e.g., a step-by-step run), providing options as to which decision should be taken.

In some embodiments of the invention, an agent can learn a decision policy, taking into account uncertainty in the input data (e.g. such as a ship arrival time). In some embodiments, this can enable the recommendation of decisions that are more robust, and/or decisions that are more resilient to fluctuations in input data.

In some embodiments, during a training procedure, an agent can explore different combinations of local decisions, while monitoring a global reward (i.e., a quantitative measure of the value of the decisions recommended by the agent). In some embodiments, while each agent focuses on each decision point, the global reward system can take all of the agent's decisions into account. In some embodiments, using this approach can ensure that each agent considers the impact of its local decisions on other agents, and allows each agent to cooperate with other agents, where the common goal is to maximize the global reward.

In some embodiments of the invention, each agent's decision policy priority can be to recommend a feasible solution first. In some embodiments, this can be expressed by very high penalties that any agent would incur for breaking the feasibility constraints. In some embodiments, this can allow each agent to recommend decisions that are feasible initially, and then only if the feasible solution is found, provide an optimized decision to receive higher overall global reward.

In some embodiments, each agent's task can be to learn the decision policy that produces a feasible schedule, and recommend decisions that follow an optimized plan, where targets obtained from an optimized plan are passed down to each agent. In some embodiments, an agent's goal can be to stay close to plan targets, and recommend decisions that while feasible, aim to fulfil plan targets as close as possible. In some embodiments, the use of a multi-agent approach can help to ensure that high-level average plan values can be disaggregated into the local and discrete agent decisions.

Some embodiments can improve an existing AVEVA product, in particular Spiral Suite that offers a unified supply chain management solution, where the problem of plan scheduling is meant to be captured and solved. AVEVA, the AVEVA logos and AVEVA product names are trademarks or registered trademarks of AVEVA Group plc or its affiliates in the United States and foreign countries.

Some embodiments provide an approach to break down a plan scheduling problem into the set of agents each focusing on a single decision based on the plant topology.

Some embodiments include an algorithm that determines how to extract the features to determine the scenario for an agent's decision policy.

Some embodiments include a dynamic programming algorithm that is used for the training the policy and assigning the value for the actions in a given state. In some embodiments, this includes the usage of a nearest neighbor to find closest known states based on the input state features.

Some embodiments include a simulation algorithm based on a discrete event simulator. In some embodiments, the simulation can be used to evaluate the effect of the decision. In some embodiments, the simulator can be used during an agent's training phase to evaluate the value of each agent's decision.

Some embodiments include a training algorithm that uses one or more Monte Carlo simulations for sampling input data and for training an agent. This provides more scenarios for training which improves generalization for the future predictions.

Some embodiments provide for normalization of the global reward and its computation algorithms, which can allow for agent coordination by taking into account all agents' decisions.

Some embodiments provide an approach to predict additional metrics on each step of an agent's decision using a decision tree regression.

Some embodiments provide for a meta-policy approach used for explanation of the agent's decision strategy using simple heuristics rules.

Some embodiments provide an approach using a deep “Q-Network and REINFORCE” to represent and train each agent's policy network.

Some embodiments comprise the construction of a multi-agent model that correspond to individual customer plant. In some embodiments, each agent can correspond to a decision point that can be specific to each plant.

Some embodiments provide a training-phase plant multi-agent model. Some embodiments can use historical data, which includes historical reports, operators log-book and/or any other form of data that provides the list of scheduling decisions for a given scenario. Some further embodiments can train the agent using a Monte Carlo simulation to explore more states that have not been experienced in that past.

Some embodiments provide full-run prediction phase, and can use the trained policy to rank the decisions. For example, given a new scenario, in some embodiments, the system can extract features that describes the situation. Some embodiments can pass the input features into agent decision policy and obtain the numeric ranking of all the possible actions in a given state. Further, some embodiments include an optimal-policy scenario agent selects that action that has the highest number representing the ranking. Further, some embodiments can invoke all relevant agents for a whole plan scheduling period and populate the decision points with all agent's recommendation.

Some embodiments provide a step-by-step prediction phase, and use the trained policy and step through each decision point and invoke agent policy. For example, some embodiments use a discrete event simulator that steps through the decision points that need a decision to be taken. Further, in some embodiments, for each of the decision points that invoke the relevant agent, the system can extract input features for each step, feed it through agent network, and rank decisions.

Some embodiments provide an option for the user to choose a recommended decision or allow the user to choose any other action. Some other embodiments provide a follow-up of the selection choice of decision. Some embodiments provide an understanding of an agent's decisions.

In some embodiments, in order to facilitate the understanding of agent's decision, there can be additional metrics that are predicted for each of decision ranking. In some embodiments, these metrics include the forecast of whether following the particular policy and choosing a decision which leads to feasible schedule. Further, some embodiments provide a forecast on the final global reward. Some embodiments provide additional metrics help to explain the rationale behind the numerical ranking of the decision that agent is recommending. In some embodiments, it also enables visualization of the difference and global impact of each decision in the particular step. Some further embodiments provide an explanation of an agent's strategy behind the decision recommendation.

Some embodiments provide methods to combine heuristics rules and decision recommendations. In some embodiments, during a training phase, an agent can look at possible actions, and using dynamic programming and policy iteration, explore promising action paths in order to find sequence of decisions that maximize the global reward. This step is combined with heuristics steps, where for each decision point, agents can determine the possible actions by using set of heuristics. In some embodiments, this reduces the search space, and attaches the heuristic rule to each action.

Some embodiments provide heuristics rules to provide the final explanation during a prediction phase, as they explain the logic of how the particular decision had been taken. In some embodiments, the same set of heuristics rules, which can act a guide, can be passed along to the plant execution team along with the final detailed decisions.

Some non-limiting examples of heuristics rules include:

(i) choose tank which is not occupied and has the most material of all available tanks;

(ii) use maximum possible pumping rate; and

(iii) minimize the waiting time for the ship in queue.

FIG. 1 schematically illustrates two process units P1 and P2 in a refinery with a pipe S (or, alternatively, on a geographical scale, two plants in a network with a transport.)

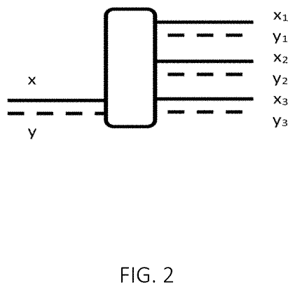

FIG. 2 shows a crude distillation unit which distills two input components into three tower output products.

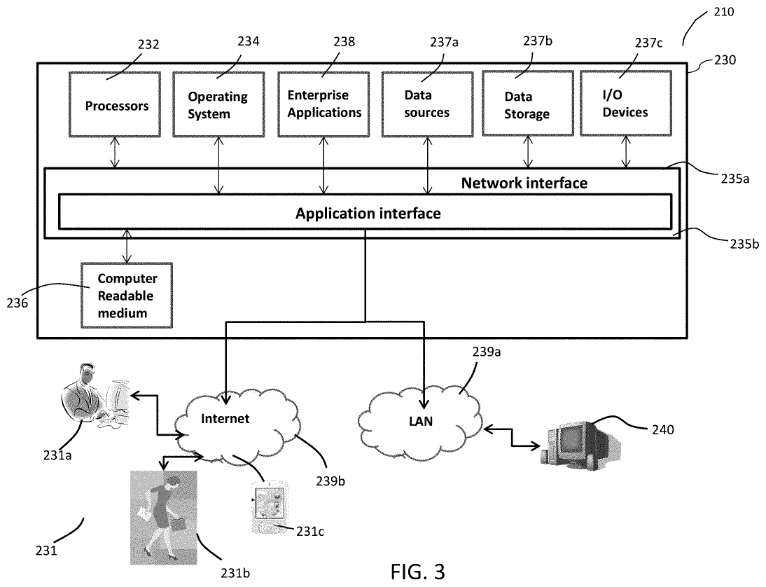

FIG. 3 illustrates a computer system enabling or comprising the systems and methods in accordance with some embodiments of the invention. In some embodiments, the computer system 200 can operate and/or process computer-executable code of one or more software modules of the aforementioned system, including any disclosed API of the system and method. Further, in some embodiments, the computer system 200 can operate and/or display information within one or more graphical user interfaces integrated with or coupled to the system.

In some embodiments, the system 200 can comprise at least one computing device including at least one processor 232. In some embodiments, the at least one processor 232 can include a processor residing in, or coupled to, one or more server platforms. In some embodiments, the system 200 can include a network interface 250a and an application interface 250b coupled to the least one processor 232 capable of processing at least one operating system 240. Further, in some embodiments, the interfaces 250a, 250b coupled to at least one processor 232 can be configured to process one or more of the software modules (e.g., such as enterprise applications 238). In some embodiments, the software modules 238 can include server-based software, and can operate to host at least one user account and/or at least one client account, and operating to transfer data between one or more of these accounts using the at least one processor 232.

With the above embodiments in mind, it should be understood that the invention can employ various computer-implemented operations involving data stored in computer systems. Moreover, the above-described databases and models described throughout can store analytical models and other data on computer-readable storage media within the system 200 and on computer-readable storage media coupled to the system 200. In addition, the above-described applications of the system can be stored on computer-readable storage media within the system 200 and on computer-readable storage media coupled to the system 200. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. In some embodiments of the invention, the system 200 can comprise at least one computer readable medium 236 coupled to at least one data source 237a, and/or at least one data storage device 237b, and/or at least one input/output device 237c. In some embodiments, the invention can be embodied as computer readable code on a computer readable medium 236. In some embodiments, the computer readable medium 236 can be any data storage device that can store data, which can thereafter be read by a computer system (such as the system 200). In some embodiments, the computer readable medium 236 can be any physical or material medium that can be used to tangibly store the desired information or data or instructions and which can be accessed by a computer or processor 232. In some embodiments, the computer readable medium 236 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 236 can transmit or carry instructions to a computer 240 and/or at least one user 231, including a router, private or public network, or other transmission device or channel, both wired and wireless. In some embodiments, the software modules 238 can be configured to send and receive data from a database (e.g., from a computer readable medium 236 including data sources 237a and data storage 237b that can comprise a database), and data can be received by the software modules 238 from at least one other source. In some embodiments, at least one of the software modules 238 can be configured within the system to output data to at least one user 231 via at least one graphical user interface rendered on at least one digital display.

In some embodiments of the invention, the computer readable medium 236 can be distributed over a conventional computer network via the network interface 250a where the system embodied by the computer readable code can be stored and executed in a distributed fashion. For example, in some embodiments, one or more components of the system 200 can be coupled to send and/or receive data through a local area network (“LAN”) 239a and/or an internet coupled network 239b (e.g., such as a wireless internet). In some further embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of user devices such as personal computers including for example desktop computers, and/or laptop computers, or any fixed, generally non-mobile internet appliances coupled through the LAN 239a. For example, some embodiments include personal computers 240a coupled through the LAN 239a that can be configured for any type of user including an administrator. Other embodiments can include personal computers coupled through network 239b. In some further embodiments, one or more components of the system 200 can be coupled to send or receive data through an internet network (e.g., such as network 239b). For example, some embodiments include at least one user 231 coupled wirelessly and accessing one or more software modules of the system including at least one enterprise application 238 via an input and output (“I/O”) device 237c. In some other embodiments, the system 200 can enable at least one user 231 to be coupled to access enterprise applications 238 via an I/O device 237c through LAN 239a. In some embodiments, the user 231 can comprise a user 231a coupled to the system 200 using a desktop computer, and/or laptop computers, or any fixed, generally non-mobile internet appliances coupled through the internet 239b. In some further embodiments, the user 231 can comprise a mobile user 231b coupled to the system 200. In some embodiments, the user 231b can use any mobile computing device 231c to wireless coupled to the system 200, including, but not limited to, personal digital assistants, and/or cellular phones, mobile phones, or smart phones, and/or pagers, and/or digital tablets, and/or fixed or mobile internet appliances.

A crib sheet that describes the directional stream value analysis report for a crude distillation unit (CDU) is attached as Exhibit A.

An example spreadsheet produced according to a directional stream value analysis is provided as Exhibit B.

A crib sheet which makes the case for critical constraint analysis is attached as Exhibit C.

A crib sheet which makes the case for global economic analysis is attached as Exhibit D.

Exhibit E includes User Interface Designs.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A optimization modeling system comprising:
one or more computers comprising one or more processors and one or more non-transitory computer readable media, the one or more non-transitory computer readable media comprising instructions stored thereon that when executed cause the one or more computers to:
generate, by the one or more processors, a model of an industrial process comprising a linear program comprising one or more equations that includes one or more flow variables associated with one or more flow components;
store, by the one or more processors, a relation of each of the one or more flow variables to any of the one or more equations in which the one or more flow variables are incident with a nonzero coefficient;
compute, by the one or more processors, changes in the one or more flow variables in in response to a material injection into the model; and
determine, by the one or more processors, a stream value by summing a downstream impact or an upstream impact of the material injection.

2. The optimization modeling system of claim 1,
the one or more non-transitory computer readable media comprising instructions stored thereon that when executed further cause the one or more computers to:
obtain one or more directional stream values by weighting one or more downstream impacts and one or more upstream impacts according to a change in flow.

3. The optimization modeling system of claim 2,
the one or more non-transitory computer readable media comprising instructions stored thereon that when executed further cause the one or more computers to:
sum the one or more directional stream values.

4. The optimization modeling system of claim 1,
the one or more non-transitory computer readable media comprising instructions stored thereon that when executed further cause the one or more computers to:
decompose, by the one or more processors, the stream value based on economic impacts of interactions with one or more downstream flow components.

5. The optimization modeling system of claim 1,
the one or more non-transitory computer readable media comprising instructions stored thereon that when executed further cause the one or more computers to:
display, by the one or more processors, explanatory information alongside the stream value.

6. The optimization modeling system of claim 1,
the one or more non-transitory computer readable media comprising instructions stored thereon that when executed further cause the one or more computers to:
subtract, by the one or more processors, a marginal-coefficient breakdown for the one or more flow components weighted by a marginal downstream flow of the one or more flow components in response to the material injection.

7. The optimization modeling system of claim 1,
wherein the optimization modeling system is configured to display economic impacts due to one or more backed-out components.

8. The optimization modeling system of claim 1,
wherein the optimization modeling system is configured to display residual economic impacts due to material processed downstream.

9. The optimization modeling system of claim 1,
where the stream value is based entirely on a single run of the linear program.

10. A modeling system comprising:
one or more computers comprising one or more processors and one or more non-transitory computer readable media, the one or more non-transitory computer readable media comprising instructions stored thereon that when executed cause the one or more computers to:
generate, by the one or more processors, a model of an industrial process comprising a linear program comprising one or more equations that includes one or more flow variables associated with one or more flow components;
store, by the one or more processors, a relation of each of the one or more flow variables to any of the one or more equations in which the one or more flow variables are incident with a nonzero coefficient;
compute, by the one or more processors, changes in the one or more flow variables in in response to a material injection into the model; and
determine, by the one or more processors, a stream value.

11. The modeling system of claim 10,
the one or more non-transitory computer readable media comprising instructions stored thereon that when executed further cause the one or more computers to:
determine the stream value by summing a downstream impact or an upstream impact of the material injection; and
determine one or more directional stream values by weighting one or more downstream impacts and one or more upstream impacts according to a change in flow.

12. The modeling system of claim 11,
the one or more non-transitory computer readable media comprising instructions stored thereon that when executed further cause the one or more computers to:
sum the one or more directional stream values.

13. The modeling system of claim 1,
the one or more non-transitory computer readable media comprising instructions stored thereon that when executed further cause the one or more computers to:
decompose, by the one or more processors, the stream value based on economic impacts of interactions with one or more downstream flow components.

14. The modeling system of claim 1,
the one or more non-transitory computer readable media comprising instructions stored thereon that when executed further cause the one or more computers to:
display, by the one or more processors, explanatory information alongside the stream value.

15. The modeling system of claim 1,
the one or more non-transitory computer readable media comprising instructions stored thereon that when executed further cause the one or more computers to:
subtract, by the one or more processors, a marginal-coefficient breakdown for the one or more flow components in response to the material injection.

16. The modeling system of claim 1,
wherein the optimization modeling system is configured to display economic impacts.

17. The modeling system of claim 1,
wherein the optimization modeling system is configured to display residual economic impacts due to downstream processing.

18. The modeling system of claim 1,
where the stream value is based entirely on a single run of the linear program.
